(19) United States
(12) Patent Application Publication
(10) Pub. No.: US 2024/0102313 A1
(43) Pub. Date: Mar. 28, 2024

(54) COMBINATION LOCK FOR PREVENTING UNINTENTIONAL DIALING OF CHARACTER DISCS

(71) Applicant: ABA LOCKS INTERNATIONAL CO., LTD., NEW TAIPEI CITY (TW)

(72) Inventor: MIKO LEE, NEW TAIPEI CITY (TW)

(21) Appl. No.: 17/936,081

(22) Filed: Sep. 28, 2022

(51) Int. Cl. E05B 9/08; E05B 37/12

(52) U.S. Cl. CPC E05B 9/08; E05B 37/12

(57) ABSTRACT

A combination lock for preventing unintentional dialing of character discs has a lock housing and a combination assembly. A cover panel of a front cap of the lock housing has at least three disc-hole sets each of which has at least one disc hole. The combination assembly is mounted in the lock housing and includes at least three lock core assemblies, each of which includes a shaft and at least one character disc mounted on the shaft. The at least one character disc of one of the lock core assemblies and the at least one character disc of an adjacent one of the lock core assemblies are arranged in staggered positions. When one of the at least one character disc is dialed, other character discs surrounding the character disc to be dialed is not unintentionally dialed, which allows convenient use of the combination lock.

### 1. FIELD OF THE INVENTION

The present invention relates to a combination lock, especially to a combination lock with character discs that are arranged in staggered positions for preventing unintentional dialing of the character discs.

### 2. DESCRIPTION OF THE PRIOR ART(S)

A combination lock is a commonly used simple lock. A lock core of the combination lock includes multiple character discs mounted on at least one shaft. Each of the character discs has characters, usually numbers, on it. By dialing the character discs, the lock core can be switched to become locked or unlocked. Accordingly, it is not necessary to carry a key and is convenient to use the combination lock. Moreover, by increasing a number of the character discs of the combination lock, complexity of the combination lock can be increased and security of the combination lock can be improved.

Since the character discs are mounted on the shaft, the character discs of the combination lock are arranged in a matrix form. For instance, with reference to FIG. 10, one of the conventional combination locks 50 is shown and its character discs 51 are arranged in a two by two matrix form; or with reference to FIG. 11, another one of the conventional combination lock 60 is shown and its character discs 61 are arranged in a three by one matrix form. The character discs that are arranged along the same column are mounted on the same shaft.

However, arranging the character discs in the matrix form has problems as follows. When intending to increase the number of the character discs or a volume of the combination lock, it has to decrease distances between adjacent character discs. Thus, as a user dials one of the character discs, other character discs surrounding the character disc to be dialed would be accidentally turned easily at the same time. Consequently, the user has to repeatedly confirm whether the character disc that has been adjusted is unintentionally dialed, which causes the combination lock being inconvenient to use.

To overcome the shortcomings, the present invention provides a combination lock for preventing unintentional dialing of character discs to mitigate or obviate the aforementioned problems.

### SUMMARY OF THE INVENTION

The main objective of the present invention is to provide a combination lock for preventing unintentional dialing of character discs. The combination lock includes a lock housing and a combination assembly.

The lock housing has an accommodating chamber, a bottom cap, and a front cap. The accommodating chamber is defined inside the lock housing. The front cap is mounted on and around a front end of the bottom cap and is rotatable relative to the bottom cap. A front end of the front cap is closed with a cover panel. The cover panel has at least three disc-hole sets arranged in linear order. Each of the disc-hole sets has at least one disc hole. The at least one disc hole of one of the disc-hole sets and the at least one disc hole of an adjacent one of the disc-hole sets are arranged in staggered positions.

The combination assembly is mounted in the accommodating chamber of the lock housing and includes at least three lock core assemblies. The lock core assemblies correspond in position to the disc-hole sets respectively. Each of the lock core assemblies includes a shaft and at least one character disc. Each of the at least one character disc is mounted on the shaft and is exposed to an outside of the front cap from one of the at least one disc hole of a corresponding one of the disc-hole sets of the front cap. Thus, the at least one character disc of one of the lock core assemblies and the at least one character disc of an adjacent one of the lock core assemblies are arranged in staggered positions.

The character discs of the lock core assemblies are arranged in the staggered positions, and distances between the character discs of one lock core assembly are increased. Therefore, when the user dials one of the at least one character disc of one of the lock core assemblies, other character discs surrounding the character disc to be dialed is not unintentionally dialed, which allows convenient use of the combination lock of the present invention.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a combination lock for preventing unintentional dialing of character discs in accordance with the present invention;

FIG. 2 is an exploded perspective view of the combination lock in FIG. 1;

FIG. 3 is another exploded perspective view of the combination lock in FIG. 1;

FIG. 4 is an exploded perspective view of a combination assembly of the combination lock in FIG. 1;

FIG. 5 is another exploded perspective view of a combination assembly of the combination lock in FIG. 1;

FIG. 6 is a cross-sectional front view of the combination lock in FIG. 1;

FIG. 7 is an operational cross-sectional front view of the combination lock in FIG. 1;

FIG. 8 is another operational cross-sectional front view of the combination lock in FIG. 1;

FIG. 9 is a cross-sectional top view of the combination lock in FIG. 1;

FIG. 10 is a perspective view of a combination lock in accordance with the prior art; and

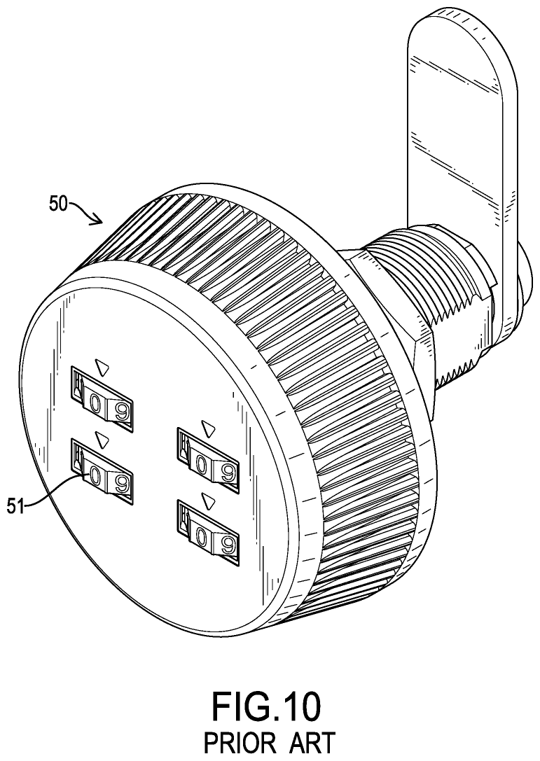

FIG. 11 is another perspective view of a combination lock in accordance with the prior art.

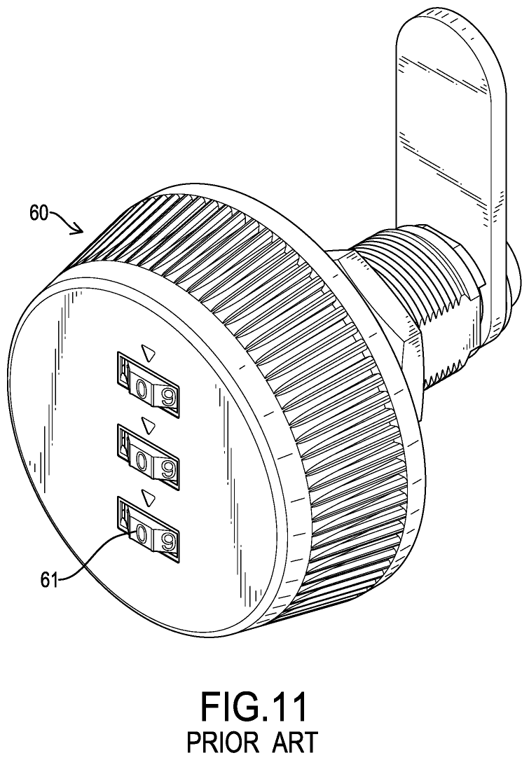

### DETAILED DESCRIPTION OF THE PREFERRED EMBODIMENTS

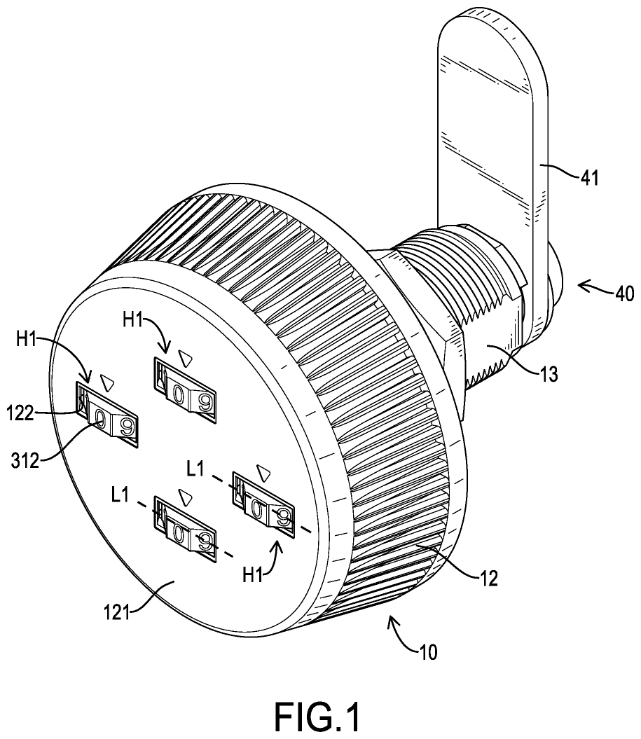

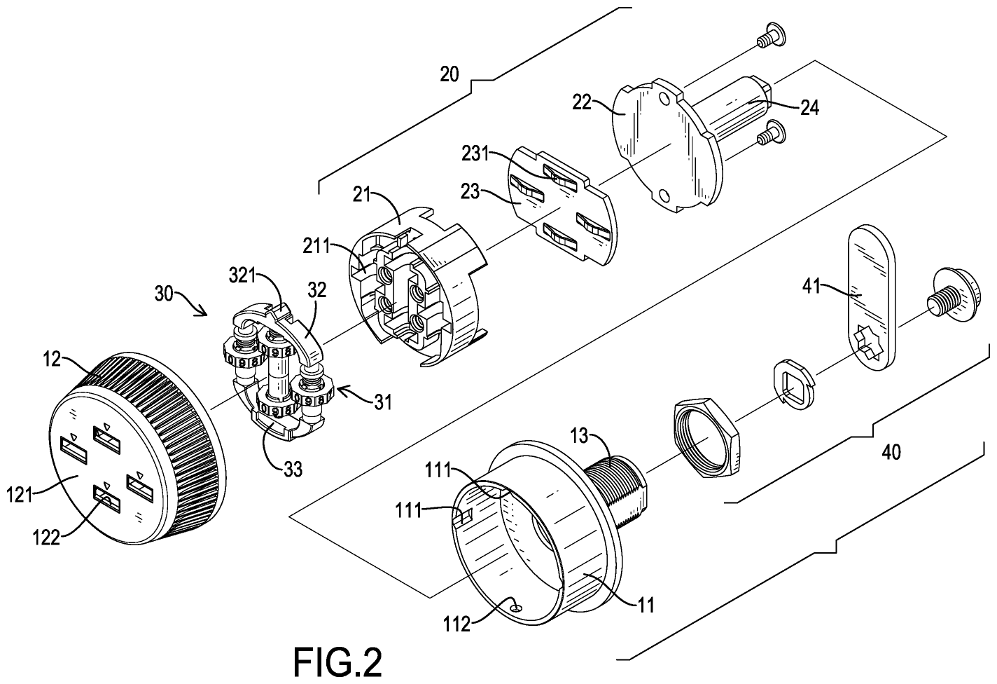

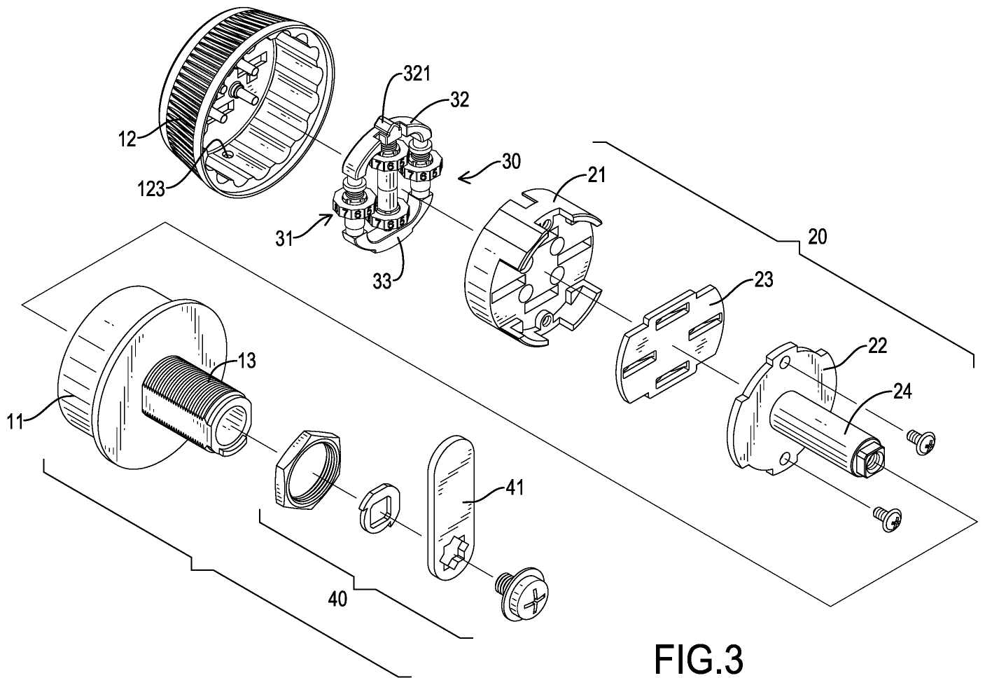

With reference to FIGS. 1 to 3, a combination lock in accordance with the present invention comprises a lock housing 10, a mounting assembly 20, a combination assembly 30, and a latch assembly 40.

The lock housing 10 has an accommodating chamber, a bottom cap 11, a mounting tube 13, and a front cap 12. The accommodating chamber is defined inside the lock housing 10.

The bottom cap 11 has a front end formed as an opening and a rear end formed as a closed end, and has multiple positioning recesses 111 and an inner through hole 112. The positioning recesses 111 are separately formed in and arranged around an inner side surface of the bottom cap 11. The mounting tube 13 axially protrudes rearward from the rear end of the bottom cap 11.

The front cap 12 is mounted on and around the front end of the bottom cap 11 and is rotatable relative to the bottom cap 11. The front cap 12 has a rear end, a front end, and an outer through hole 123. The rear end of the front cap 12 is formed as an opening for receiving the bottom cap 11. The front end of the front cap 12 is closed with a cover panel 121. The outer through hole 123 is able to aligns with the inner through hole 112 of the bottom cap 11.

The cover panel 121 of the front cap 12 has at least three disc-hole sets H1. The disc-hole sets H1 are arranged in linear order. Each of the disc-hole sets H1 has at least one disc hole 122. The at least one disc hole 122 of one of the disc-hole sets H1 and the at least one disc hole 122 of an adjacent one of the disc-hole sets H1 are arranged in staggered positions.

Specifically, each of the at least one disc hole 122 is elongated and extends along a lengthwise extension line L1. The lengthwise extension line L1 of each of the at least one disc hole 122 of each of the disc-hole sets H1 is parallel with and does not overlap with the lengthwise extension line L1 of any one of the at least one disc hole 122 of the adjacent one of the disc-hole sets H1.

Specifically, the disc-hole sets H1 are arranged along a transverse direction. In each of the disc-hole sets H1 that has a plurality of disc holes 122, the disc holes 122 are arranged along a longitudinal direction. The lengthwise extension line L1 extends along the transverse direction.

The mounting assembly 20 is mounted in the accommodating chamber of the lock housing 10 and includes a mounting seat 21, a retaining panel 22, a mounting rod 24, and a positioning panel 23.

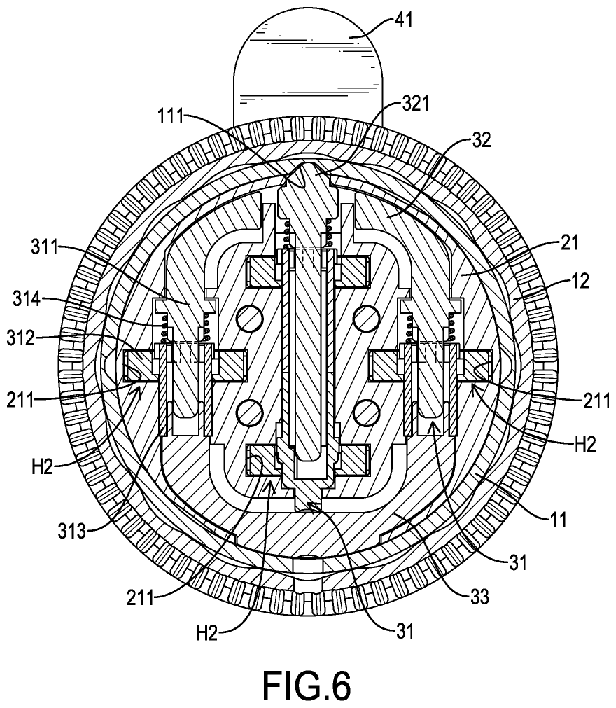

With further reference to FIG. 6, the mounting seat 21 is substantially cylindrical and is securely connected with the front cap 12, such that the mounting seat 21 can rotate relative to the bottom cap 11 together with the front cap 12. The mounting seat 21 has a front end surface, a rear end surface, and at least three disc-recess set H2. The front end surface of the mounting seat faces toward the cover panel 121 that is disposed on the front end of the front cap 12. The rear end surface of the mounting seat 21 faces toward the rear end of the bottom cap 11. The disc-recess sets H2 are arranged in linear order and correspond in position to the disc-hole sets H1 respectively. Each of the disc-recess sets H2 has at least one disc recess 211. Each of the at least one disc recess 211 extends between and through the front end surface of the mounting seat 21 and the rear end surface of the mounting seat 21 and aligns with one of the at least one disc hole 122 of a corresponding one of the disc-hole sets H1. Thus, the at least one disc recess 211 of one of the disc-recess sets H2 and the at least one disc recess 211 of an adjacent one of the disc-recess sets H2 are arranged in staggered positions.

The retaining panel 22 is securely mounted on the rear end surface of the mounting seat 21. The mounting rod 24 axially protrudes rearward from the retaining panel 22, and is mounted through and protrudes out of the mounting tube 13 that is disposed on the bottom cap 11.

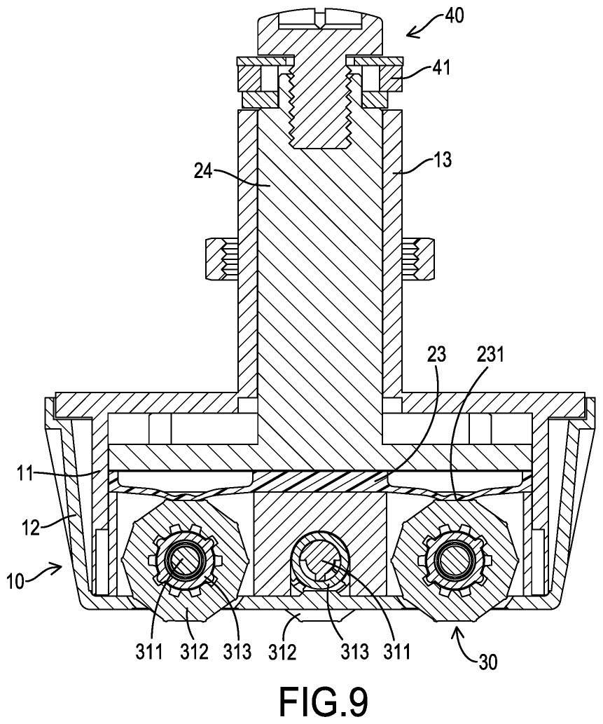

With further reference to FIG. 9, the positioning panel 23 is mounted on the rear end surface of the mounting seat 21 and is held between the rear end surface of the mounting seat 21 and the retaining panel 22, and has multiple resilient positioning tabs 231. The resilient positioning tabs 231 protrude toward the mounting seat 21 and correspond in position to the disc recesses 211 of the mounting seat 21 respectively.

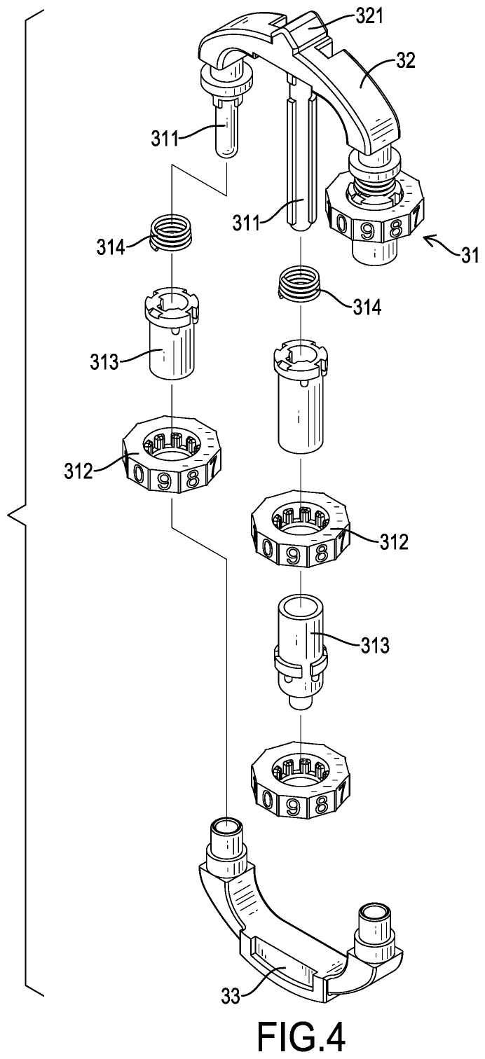

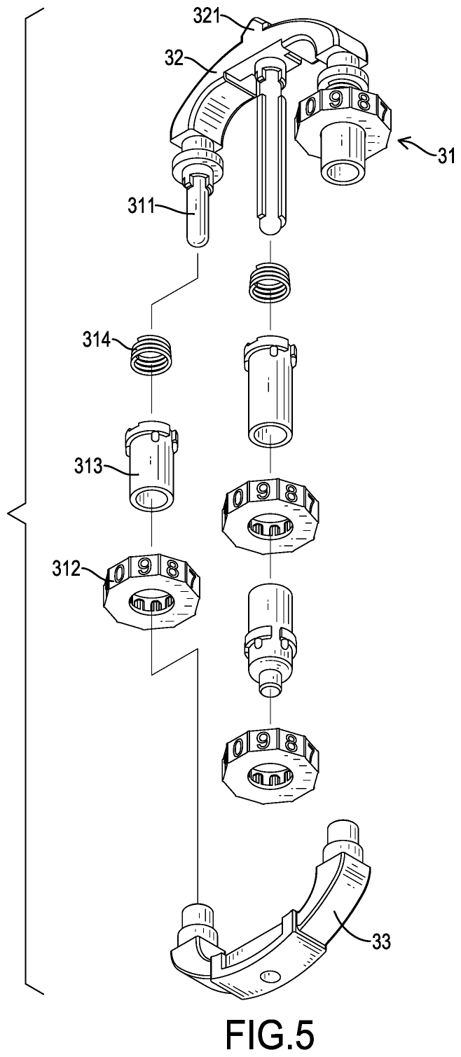

With further reference to FIGS. 4 and 5, the combination assembly 30 is mounted in the accommodating chamber of the lock housing 10, is mounted to the front end surface of the mounting seat 21, and includes at least three lock core assemblies 31, a connecting rod 32 and a combination rod 33.

The lock core assemblies 31 are arranged in linear order, correspond in position to the disc-hole sets H1 respectively, and correspond in position to the disc-recess sets H2 respectively. Each of the lock core assemblies 31 includes a shaft 311, at least one character disc 312 and a restoring resilient element 314. Each of the at least one character disc 312 is mounted on and around a sleeve 313 and the sleeve 313 is mounted around the shaft 311. Each of the at least one character disc 312 is mounted in one of the at least one disc recess 211 of a corresponding one of the disc-recess sets H2 and is exposed to an outside of the front cap 12 from one of the at least one disc hole 122 of a corresponding one of the disc-hole sets H1 of the front cap 12. Thus, the at least one character disc 312 of one of the lock core assemblies 31 and the at least one character disc 312 of an adjacent one of the lock core assemblies 31 are arranged in staggered positions. Moreover, each of the resilient positioning tabs 231 of the positioning panel 23 abuts against a corresponding one of the character discs 312, such that the character disc 312 is held at a specific angular position.

The restoring resilient element 314 has two ends pushing against the shaft 311 and the at least one sleeve 313 respectively, such that when the at least one sleeve 313 and the shaft 311 move relative to each other along an axial direction of the shaft 311, the restoring resilient element 314 resiliently pushes the at least one sleeve 313 and the shaft 311 to restore their positions.

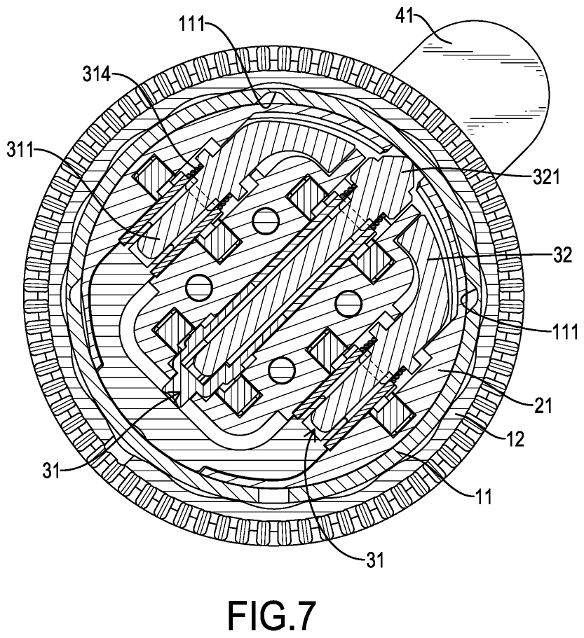

With further reference to FIGS. 6 and 7, the connecting rod 32 is connected with the shafts 311 of the lock core assemblies 31 at an end of the shaft 311 of each of the lock core assemblies 31, such that the shafts 311 of the lock core assemblies 31 can be moved together. The connecting shaft 32 has a positioning protrusion 321 selectively engaging in one of the positioning recesses 111 of the bottom cap 11. Furthermore, when the front cap 12 and the mounting seat 21 rotate relative to the bottom cap 11 until the positioning protrusion 321 of the connecting rod 32 corresponds in position to one of the positioning recesses 111 of the bottom cap 11, the restoring resilient elements 314 of the lock core assemblies 31 push the shafts 311 and the connecting rods 32, to make the positioning protrusion 321 of the connecting rod 32 engage in said positioning recess 111 of the bottom cap 11.

Specifically, the at least one sleeve 313 and the shaft 311 of each of the lock core assemblies 31 detachably engage with each other. When each of the character discs 312 is dialed and drives the sleeve 313 to turn to an angular position that the sleeve 313 is able to disengage from the shaft 311, the sleeve 313 and the shaft 311 can move relative to each other along the axial direction of the shaft 311. Thus, as the front cap 12 is rotated, the front cap 12 presses the connecting rod 32 to drive the shafts 311 of the lock core assemblies 31 to move along the axial directions of the shafts 311. The combination lock is unlocked. When each of the character discs 312 is dialed and drives the sleeve 313 to turn to an angular position that the sleeve 313 engages with the shaft 311, the sleeve 313 and the shaft 311 are unable to move relative to each other. Thus, the connecting rod 32 is unable to drive the shafts 311 to move and the positioning protrusion 321 of the connecting rod 32 engages in one of the positioning recesses 111 of the bottom cap 11. The front cap 12 is unable to be rotated and the combination lock is locked.

Specifically, in each of the lock core assemblies 31, each of the at least one character disc 312 detachably engages with the sleeve 313. When the character disc 312 disengages from the sleeve 313, the character disc 312 is rotatable relative to the sleeve 313, such that a relative angular position of the character disc 312 and the sleeve 313 can be changed.

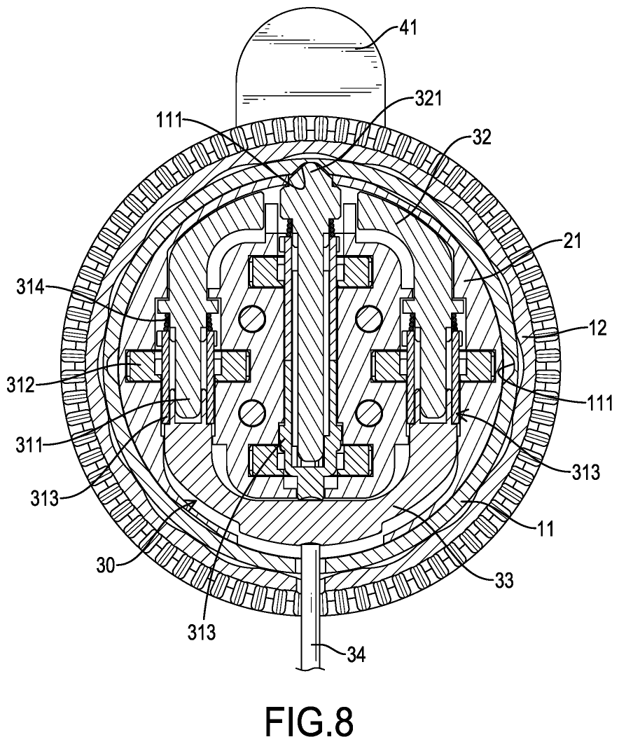

With further reference to FIG. 8, the combination rod 33 is connected to one of the at least one sleeve 313 of each of the lock core assemblies 31 and corresponds in position to the inner through hole 112 of the bottom cap 11 and the outer through hole 123 of the front cap 12. A user can press the combination rod 33 by inserting a pin 34 through the outer through hole 123 and the inner through hole. The combination rod 33 that is pressed drives the sleeves 313 of the lock core assemblies 31 to move along the axial directions of the shafts 311 and to disengage from the character discs 312. Thus, each of the character discs 312 can be turned to change the relative angular position of the character disc 312 and the sleeve 313, so as to change password of the combination lock.

The latch assembly 40 is mounted on the mounting tube 13 of the bottom cap 11 and the mounting rod 24 of the mounting assembly 20. The latch assembly 40 has a latch 41 securely mounted on the mounting rod 24 of the mounting assembly 20. Thus, the latch 41 is rotatable together with the front cap 12 and can be rotated to a close position or an open position.

As shown in FIGS. 1, 2, 4, and 6, in the preferred embodiment of the present invention, the at least three lock core assemblies 31 includes three lock core assemblies 31. The lock core assembly 31 that is disposed at the middle has two character discs 312 separately disposed. The lock core assemblies 31 that are disposed at two opposite sides has one character disc 312. Correspondingly, the at least three disc-hole sets H1 on the front cap 12 includes three disc-hole sets H1. In order to cooperate with the lock core assemblies 31, the three disc-hole sets H1 have one disc hole 122, two disc holes 122 and one disc hole 122 in sequence. The at least three disc-recess sets H2 on the mounting seat 21 includes three disc-recess sets H2. In order to cooperate with the lock core assemblies 31, the three disc-recess sets H2 have one disc recess 211, two disc recesses 211 and one disc recess 211 in sequence. Thus, there are four character discs 312 protruding from the front cap 12 of the combination lock. The character discs 312 of the lock core assemblies 31 that are disposed at the two opposite sides are disposed between the two character discs 312 of the lock core assembly 31 that is disposed at the middle. Accordingly, the character discs 312 of the three lock core assemblies 31 are arranged in the staggered positions.

As shown in FIG. 1, the combination lock as described as the following advantages. The character discs 312 of the lock core assemblies 31 are arranged in the staggered positions, and distances between the character discs 312 of one lock core assembly 31 are increased. Therefore, when the user dials one of the at least one character disc 312 of one of the lock core assemblies 31, other character discs 312 surrounding the character disc to be dialed is not unintentionally dialed, which allows convenient use of the combination lock of the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A combination lock comprising:
a lock housing having
an accommodating chamber defined inside the lock housing;
a bottom cap; and
a front cap mounted on and around a front end of the bottom cap and being rotatable relative to the bottom cap, and a front end of the front cap being closed with a cover panel, wherein the cover panel has at least three disc-hole sets arranged in linear order, each of the disc-hole sets has at least one disc hole, and the at least one disc hole of one of the disc-hole sets and the at least one disc hole of an adjacent one of the disc-hole sets are arranged in staggered positions; and
a combination assembly mounted in the accommodating chamber of the lock housing and including at least three lock core assemblies, the lock core assemblies corresponding in position to the disc-hole sets respectively, and each of the lock core assemblies including
a shaft; and
at least one character disc, each of the at least one character disc mounted on the shaft and exposed to an outside of the front cap from one of the at least one disc hole of a corresponding one of the disc-hole sets of the front cap, thereby the at least one character disc of one of the lock core assemblies and the at least one character disc of an adjacent one of the lock core assemblies arranged in staggered positions.

2. The combination lock as claimed in claim 1, wherein
each of the at least one disc hole is elongated and extends along a lengthwise extension line; and
the lengthwise extension line of each of the at least one disc hole of each of the disc-hole sets is parallel with and does not overlap with the lengthwise extension line of any one of the at least one disc hole of the adjacent one of the disc-hole sets.

3. The combination lock as claimed in claim 1, wherein
the combination lock further comprises a mounting assembly mounted in the accommodating chamber of the lock housing and including a mounting seat, the mounting seat securely connected with the front cap and being rotatable relative to the bottom cap together with the front cap, the mounting seat having at least three disc-recess set corresponding in position to the disc-hole sets respectively, each of the disc-recess sets having at least one disc recess, and each of the at least one disc recess aligning with one of the at least one disc hole of the corresponding one of the disc-hole sets, thereby the at least one disc recess of one of the disc-recess sets and the at least one disc recess of an adjacent one of the disc-recess sets arranged in staggered positions.
the combination assembly is mounted to a front end surface of the mounting seat;
the lock core assemblies of the combination assembly correspond in position to the disc-recess sets respectively; and
each of the at least one character disc of each of the lock core assemblies is mounted in one of the at least one disc recess of a corresponding one of the disc-recess sets.

4. The combination lock as claimed in claim 2, wherein
the combination lock further comprises a mounting assembly mounted in the accommodating chamber of the lock housing and including a mounting seat, the mounting seat securely connected with the front cap and being rotatable relative to the bottom cap together with the front cap, the mounting seat having at least three disc-recess set corresponding in position to the disc-hole sets respectively, each of the disc-recess sets having at least one disc recess, and each of the at least one disc recess aligning with one of the at least one disc hole of the corresponding one of the disc-hole sets, thereby the at least one disc recess of one of the disc-recess sets and the at least one disc recess of an adjacent one of the disc-recess sets arranged in staggered positions.
the combination assembly is mounted to a front end surface of the mounting seat;
the lock core assemblies of the combination assembly correspond in position to the disc-recess sets respectively; and
each of the at least one character disc of each of the lock core assemblies is mounted in one of the at least one disc recess of a corresponding one of the disc-recess sets.

5. The combination lock as claimed in claim 3, wherein the mounting assembly further includes a positioning panel mounted on a rear end surface of the mounting seat and having multiple resilient positioning tabs, the resilient positioning tabs corresponding in position to the disc recesses of the mounting seat respectively and abutting against a corresponding one of the character discs.

6. The combination lock as claimed in claim 4, wherein the mounting assembly further includes a positioning panel mounted on a rear end surface of the mounting seat and having multiple resilient positioning tabs, the resilient positioning tabs corresponding in position to the disc recesses of the mounting seat respectively and abutting against a corresponding one of the character discs.

7. The combination lock as claimed in claim 5, wherein
the lock housing further has a mounting tube axially protruding rearward from a rear end of the bottom cap;
the mounting assembly further includes
a retaining panel securely mounted on the rear end surface of the mounting seat; and
a mounting rod axially protruding rearward from the retaining panel, and mounted through and protruding out of the mounting tube that is disposed on the bottom cap; and
the positioning panel is held between the rear end surface of the mounting seat and the retaining panel.

8. The combination lock as claimed in claim 6, wherein
the lock housing further has a mounting tube axially protruding rearward from a rear end of the bottom cap;
the mounting assembly further includes
a retaining panel securely mounted on the rear end surface of the mounting seat; and
a mounting rod axially protruding rearward from the retaining panel, and mounted through and protruding out of the mounting tube that is disposed on the bottom cap; and
the positioning panel is held between the rear end surface of the mounting seat and the retaining panel.

9. The combination lock as claimed in claim 1, wherein
each of the at least one character disc of each of the lock core assemblies is mounted on and around a sleeve and the sleeve is mounted around the shaft; and
each of the lock core assemblies further includes a restoring resilient element having two ends pushing against the shaft and the at least one sleeve respectively.

10. The combination lock as claimed in claim 2, wherein
each of the at least one character disc of each of the lock core assemblies is mounted on and around a sleeve and the sleeve is mounted around the shaft; and
each of the lock core assemblies further includes a restoring resilient element having two ends pushing against the shaft and the at least one sleeve respectively.

11. The combination lock as claimed in claim 3, wherein
each of the at least one character disc of each of the lock core assemblies is mounted on and around a sleeve and the sleeve is mounted around the shaft; and
each of the lock core assemblies further includes a restoring resilient element having two ends pushing against the shaft and the at least one sleeve respectively.

12. The combination lock as claimed in claim 4, wherein
each of the at least one character disc of each of the lock core assemblies is mounted on and around a sleeve and the sleeve is mounted around the shaft; and
each of the lock core assemblies further includes a restoring resilient element having two ends pushing against the shaft and the at least one sleeve respectively.

13. The combination lock as claimed in claim 9, wherein
the bottom cap has an inner through hole;
the front cap has an outer through hole being able to aligns with the inner through hole of the bottom cap; and
the combination assembly further includes a combination rod connected to one of the at least one sleeve of each of the lock core assemblies and corresponding in position to the inner through hole of the bottom cap and the outer through hole of the front cap.

14. The combination lock as claimed in claim 12, wherein
the bottom cap has an inner through hole;
the front cap has an outer through hole being able to aligns with the inner through hole of the bottom cap; and
the combination assembly further includes a combination rod connected to one of the at least one sleeve of each of the lock core assemblies and corresponding in position to the inner through hole of the bottom cap and the outer through hole of the front cap.

15. The combination lock as claimed in claim 1, wherein
the bottom cap further has multiple positioning recesses separately formed in and arranged around an inner side surface of the bottom cap; and
the combination assembly further includes a connecting rod connected with the shafts of the lock core assemblies and having a positioning protrusion selectively engaging in one of the positioning recesses of the bottom cap.

16. The combination lock as claimed in claim 2, wherein
the bottom cap further has multiple positioning recesses separately formed in and arranged around an inner side surface of the bottom cap; and
the combination assembly further includes a connecting rod connected with the shafts of the lock core assemblies and having a positioning protrusion selectively engaging in one of the positioning recesses of the bottom cap.

17. The combination lock as claimed in claim 3, wherein
the bottom cap further has multiple positioning recesses separately formed in and arranged around an inner side surface of the bottom cap; and
the combination assembly further includes a connecting rod connected with the shafts of the lock core assemblies and having a positioning protrusion selectively engaging in one of the positioning recesses of the bottom cap.

18. The combination lock as claimed in claim 4, wherein
the bottom cap further has multiple positioning recesses separately formed in and arranged around an inner side surface of the bottom cap; and
the combination assembly further includes a connecting rod connected with the shafts of the lock core assemblies and having a positioning protrusion selectively engaging in one of the positioning recesses of the bottom cap.

19. The combination lock as claimed in claim 1, wherein
the at least three lock core assemblies includes three lock core assemblies, the lock core assembly that is disposed at the middle has two character discs separately disposed, and the lock core assemblies that are disposed at two opposite sides has one character disc; and
the at least three disc-hole sets on the front cap includes three disc-hole sets, and the three disc-hole sets have one disc hole, two disc holes and one disc hole in sequence.

20. The combination lock as claimed in claim 2, wherein
the at least three lock core assemblies includes three lock core assemblies, the lock core assembly that is disposed at the middle has two character discs separately disposed, and the lock core assemblies that are disposed at two opposite sides has one character disc; and
the at least three disc-hole sets on the front cap includes three disc-hole sets, and the three disc-hole sets have one disc hole, two disc holes and one disc hole in sequence.
